(19) United States
(12) Patent Application Publication
(10) Pub. No.: US 2026/0288896 A1
(43) Pub. Date: Sep. 24, 2026

(54) VARIABLE VECTOR REGISTER TILING FOR IMPROVING RESOURCE UTILIZATION IN MATRIX MULTIPLICATION

(71) Applicant: Hewlett Packard Enterprise Development LP, Spring, TX (US)

(72) Inventor: Aaron Matthew Collier, Woodbury, MN (US)

(21) Appl. No.: 19/088,578

(22) Filed: Mar. 24, 2025

(51) Int. Cl. G06F 17/16

(52) U.S. Cl. CPC G06F 17/16

(57) ABSTRACT

One aspect of the instant disclosure provides a system and method for improving register utilization in a processor. During operation, the processor may receive a request for performing a matrix-multiplication operation between a first matrix and a second matrix; and determine, for the matrix-multiplication operation, a set of valid configurations of a register tile based on a number of registers provided by the processor, a respective configuration comprising a row number and a column number. The column number is a function of the row number. The processor may then perform the matrix-multiplication operation to obtain a third matrix based on the determined set of valid configurations of the register tile.

### FIELD

This disclosure relates to a system and method for improving the performance of matrix-multiplication operations executed by vector processors. More specifically, the system employs variable vector register tiling to perform the matrix-multiplication operation.

### RELATED ART

Matrix multiplication is a cornerstone operation for numerous high-performance computing (HPC) workloads, encompassing both traditional applications such as Car-Parrinello code for the new Millenium (CP2K) and Vienna Ab initio Simulation Package (VASP), as well as contemporary machine learning (ML) and deep learning (DL) tasks. The performance of matrix multiplication directly affects the training and inference times of many ML/DL models, particularly in the realm of deep neural networks. As such, enhancing the computational efficiency of matrix multiplication is paramount for the scalability of ML/DL models, allowing them to process larger datasets and accommodate increasingly complex architectures.

A typical algorithm for multiplying two n×n matrices exhibits a time complexity of O(n³), rendering matrix multiplication a computationally demanding operation, particularly for large matrices. One optimization approach is based on Single-Instruction, Multiple-Data (SIMD) instructions, which facilitate vectorization of the matrix multiplication operation. This vectorization allows the resulting matrix to be partitioned into sub-blocks or tiles, which makes parallel processing possible. The dimensions of these sub-blocks or tiles affect the number of iterations required for completing the multiplication operation and therefore play a critical role in determining the algorithm's performance.

### BRIEF DESCRIPTION OF THE FIGURES

FIG. 1 illustrates an example register-blocking approach for matrix multiplication, according to one aspect of the instant disclosure.

FIG. 2 illustrates a table indicating the register utilization for a set of fixed tile configurations for an out-of-place implementation of matrix multiplication.

FIG. 3A illustrates a table presenting a list of valid tile configurations for the out-of-place implementation for a processor equipped with 32 registers, according to one aspect of the instant disclosure.

FIG. 3B illustrates a table presenting a list of valid tile configurations and their corresponding register utilizations for the out-of-place implementation, according to one aspect of the instant disclosure.

FIG. 4A presents a flowchart illustrating an example process for performing a matrix-multiplication operation, according to one aspect of the instant disclosure.

FIG. 4B presents a flowchart illustrating an example process for obtaining the product matrix, according to one aspect of the instant disclosure.

FIG. 5A illustrates a table indicating the register utilization for a set of fixed tile configurations for an in-place implementation.

FIG. 5B illustrates a table presenting a list of valid tile configurations for the in-place implementation for a processor equipped with 32 registers, according to one aspect of the instant disclosure.

FIG. 5C illustrates a table presenting a list of valid tile configurations and their corresponding register utilizations for the in-place implementation, according to one aspect of the instant disclosure.

FIG. 6 illustrates the relative performance improvement of the variable register tiling technique over the conventional fixed register tiling technique for the in-place implementation, according to one aspect of the instant disclosure.

FIG. 7 illustrates an example computer system facilitating variable register tiling for matrix multiplication, according to one aspect of the instant disclosure.

FIG. 8 illustrates a computer-readable medium (CRM) that facilitates matrix multiplication by variable-register-tiling, according to one aspect of the instant disclosure.

In the figures, like reference numerals refer to the same figure elements.

### DETAILED DESCRIPTION

Matrix multiplication is a fundamental operation in linear algebra that combines two matrices to produce a new matrix. This process involves multiplying rows of the first matrix, known as the multiplier matrix, by columns of the second matrix, referred to as the multiplicand matrix. The resulting matrix, referred to as the product matrix, encapsulates the combined information from both input matrices, making this operation crucial in various fields such as computer graphics, data analysis, and machine learning. An example matrix multiplication operation may be defined as c=AB, where the dimensions of matrices A, B, and c are m×k, k×n, and m×n, respectively. Each element of the product matrix c, denoted cᵢⱼ, is the dot product of the ith row of the multiplier matrix A and the jth column of the multiplicand matrix B.

A standard implementation of matrix multiplication typically employs nested loops that iterate over the three dimensions of matrices A, B, and c. These dimensions are often referred to as the m-, n-, and k-dimensions. The m- and n-dimension may also be referred to as the row- and column-dimension, respectively, because they correspond to the rows and columns in the product matrix. The order of the nested loops may be determined based on the data-access pattern. For example, when an m/n/k ordering may be chosen, the nested loops may include an outermost loop x(1: m), an intermediate loop y(1: n), and an inner most loop z(1: k,Δk), where x, y, and z are iterators, and the term Δk denotes the number of iterations used for loop unrolling, a technique employed to enhance performance by reducing loop overhead and improving instruction-level parallelism.

SIMD instructions significantly enhance the computation efficiency of matrix operations, including matrix multiplication, by allowing parallelization. SIMD processors feature wider registers, often called vector registers, capable of holding multiple data elements simultaneously. The key advantage of SIMD is that a single instruction can be applied to all elements in a vector register concurrently, allowing for the vectorization of matrix multiplication operations. This parallelism substantially increases processing speed and efficiency.

To further optimize performance, register blocking or tiling techniques can be used, which can reduce the number of memory load/store instructions and improve overall efficiency. In this approach, the resulting matrix (matrix C) is divided into sub-blocks or tiles. The size of these sub-blocks or tiles is determined by two main factors: the vector length of each register (i.e., the number of matrix elements a single register can hold) and the total number of available registers. Moreover, the arrangement of the registers may define the way the product matrix c is partitioned. This strategic partition of the product matrix allows for more efficient use of the processor's resources, particularly in terms of cache utilization and register management.

Register blocking may be applied to matrices of any size (where m, n, and k may have arbitrary values). The instant disclosure is focused on smaller matrices for several reasons. The loop management overhead and resource utilization have a more significant impact on smaller matrices. In addition, optimizing matrix multiplication for smaller matrices is important for ML/DL training workflows and introduces unique challenges. The logical complexity of matrix multiplication algorithms can significantly affect ML/DL training performance due to potential branch mispredictions leading to pipeline stalls. Furthermore, conditional checks, such as if-else statements, introduce additional execution overhead. Conventional approaches to register blocking often use fixed-size tiles, which only optimize register usage for a limited subset of input parameters. As a result, with input matrices of arbitrary m, n, and k values, the overall performance may be negatively affected in cases with very low register utilization. To improve performance of matrix multiplication across a wide range of inputs, according to aspects of the instant disclosure, a matrix multiplication kernel may be implemented using tiles of variable sizes. This approach aims to adapt to different input dimensions more effectively, optimizing register usage and overall performance for a broader range of matrix sizes and shapes.

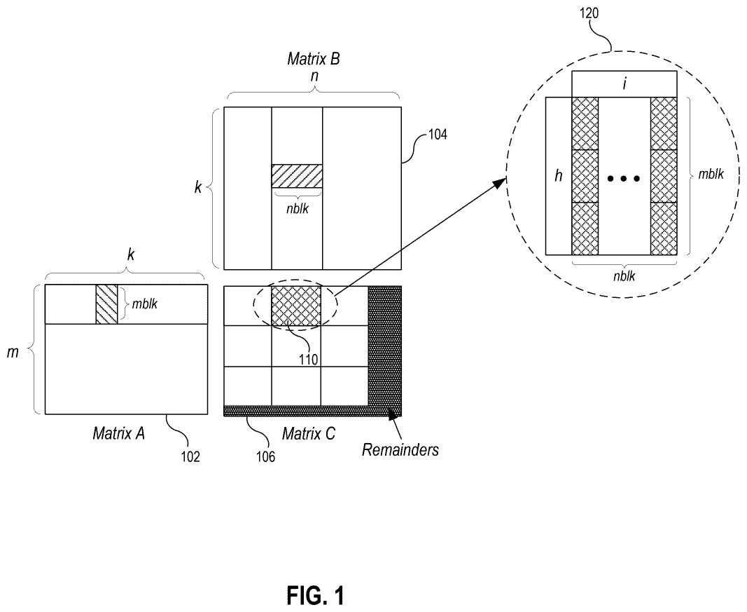

FIG. 1 illustrates an example register-blocking approach for matrix multiplication, according to one aspect of the instant disclosure. In FIG. 1, a matrix 102 (matrix A) with a dimension m×k is multiplying a matrix 104 (matrix B) with a dimension k×n to generate a product matrix 106 (matrix C), which is divided into sub-blocks or tiles, such as a tile 110. Each tile (e.g., tile 110) may be computed by loading required values from matrices A and B, stepping through the k dimension. Tile 110 may have a dimension of mblk×nblk, where mblk corresponds to the number of rows of matrix elements held in the tile, and nblk corresponds to the number of columns.

FIG. 1 also illustrates an example of the arrangement of the registers in tile 110, as shown in an amplified view 120 of tile 110. In this example, when expressed using registers, tile 110 has a size of h×i, where h is the number of registers in the row-dimension (also referred to as the m-dimension), and i is the number of registers in the column-dimension (also referred to as the n-dimension). Considering that each register may hold 1 matrix elements, the dimension of tile 110 may also be expressed using the number of matrix elements as h*l×i. In one example, the processor performing the matrix multiplication operation may include 32 registers, and each register is capable of storing 512 bits. If each matrix element is represented using a 64-bit data type, the vector length (i.e., l) is eight (i.e., each register may hold up to eight matrix elements).

Considering that the input matrices (i.e., matrices A and B) may have arbitrary dimensions, for a given tile with a dimension h*l×i, the product matrix (i.e., matrix C) may not be divisible by h*i in the row dimension or i in the column dimension. Consequently, the matrix-multiplication operation needs to consider loop remainders for dealing with the remainder rows or columns, as shown in FIG. 1. Conventional matrix multiplication algorithms often start with a base tile that has a predetermined configuration. This configuration may be determined heuristically or empirically based on the average performance across a range of input parameters. For instant, in a processor with 32 available registers, a conventional approach might select a base register tile with a configuration of h=3 and i=8, corresponding to a matrix sub-block with dimensions of 24×8, with the number of rows in the sub-block corresponding to h*l=3*8 and the number of columns in the sub-block corresponding to i=8.

For a matrix C with dimensions that are not divisible by the base tile (e.g., 24 in the row dimension or 8 in the column dimension), conventional approaches handle the remainder cases by checking smaller tiles with dimensions that are powers of two, up to the base tile dimension. In the row dimension, the algorithm may need to consider row numbers (e.g., mblk) of 24, 16, 8, 4, 2, 1. Similarly, in the column dimension, it needs to consider column numbers (e.g., nblk) of 8, 4, 2, 1. This approach leads to a significant number of conditional checks. More specifically, for each row-dimension value (i.e., the m value), the algorithm may need to check all column-dimension values (i.e., the n values), which may result in poor register utilization in many cases.

The vector register utilization (denoted c) may be defined as the total number of registers utilized for the computation of each tile divided by the total number of available registers. The total number of registers used to compute a tile in the product matrix may be determined based on f_{c}(h,i)+f_{A}(h)+f_{B}(i), where f_{c}(h,i)=h*i defines the number of registers necessary to store an h×i sub-block of product matrix C, while f_{A}(h) and f_{B}(i) define the number of registers required to store elements of matrices A and B, respectively. Functions f_{A}(h) and f_{B}(i) depend on the implementation (e.g., out-of-place/copy or in-place/no-copy implementation of the matrix multiplication).

If the matrix multiplication implements the out-of-place/copy algorithm with local buffering, f_{A}(h)=2*h and f_{B}(i)=min(2,i), which define the number of registers used for loading data for matrices A and B with loop unrolling. The term min(2,i) describes a common implementation for loading data from matrix B, in which one register stores the currently required element from matrix B, and an additional register is used to preload the next element of matrix B in the k dimension. If i=1, only one register is needed, as there are no additional elements to fetch from matrix B.

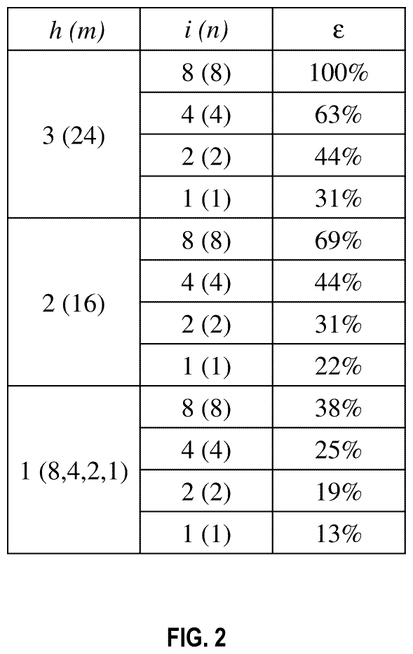

Accordingly, the register utilization can be computed as

$$ε = \frac{h * i + 2 * h + min ( 2 , i )}{N} ,$$

where N is the total number of registers provided by the processor. For the different tile configurations (e.g., different h and i values), the register utilization may be different. FIG. 2 illustrates a table indicating the register utilization for a set of fixed tile configurations in an out-of-place implementation of matrix multiplication. In this example, N equals 32, and the base tile configuration is set as h=3 and i=8, corresponding to a matrix sub-block with dimensions of 24×8. The matrix multiplication algorithm employs an m/n/k loop ordering, where the innermost loop iterates over different k values. As can be seen from FIG. 2, register utilization is less than 100% in most cases, with the exception of the base tile case. This means that while the base tile achieves optimal register usage, the remainder loops—where additional smaller tiles are used to compute the remaining rows and columns of the product matrix C—often result in suboptimal register utilization. For example, a tile configuration of h=3 and i=4 yields a register utilization of 63%, and a tile configuration of h=2 and i=8 results in a register utilization of 69%. These examples highlight the inefficiency that can occur when dealing with matrix dimensions that do not perfectly align with the base tile size.

The average register utilization (denoted E) for the set of tile configurations show in FIG. 2 may be computed according to:

$$E = {\sum }_{j = 1}^{j \leq γ} {ε}_{j} ,$$

where γ, is the total number of tile configurations in the set of tiles. In the example shown in FIG. 2. the average register utilization is only 32%. In the example presented in FIG. 2, the configuration of base tile (i.e., the largest tile) is typically determined heuristically or empirically based on the average performance (e.g., the average register utilization) over a range of inputs. Once a base tile is selected, the configurations of the additional smaller tiles become fixed, where the same set of column-dimension values (i.e., values) would be used for each row-dimension value (i.e., h values). As shown in FIG. 2, for different h values (i.e., h=3, 2, or 1), the same set of i values (i.e., i=8, 4, 2, or 1) is consistently applied. This fixed structure, while simple to implement, leads to suboptimal register utilization for many matrix sizes, particularly those that do not align well with the base tile dimensions.

To improve the performance of matrix multiplication operations, particularly by increasing the average register utilization, this disclosure proposes a variable tiling technique instead of using a fixed base tile with associated fixed-sized tiles. The register-blocking logic unit may implement this adaptive approach to divide the product matrix more efficiently. More specifically, all valid tile configurations may be considered, and a configuration with the maximum row or column dimension may be selected for register blocking, depending on the specific loop ordering used. According to further aspects, each row dimension value may correspond to a set of column dimension values, with the maximum column dimension value being a function of the row dimension value. As illustrated in FIG. 1, the size of tile 110 may be determined based on the dimensions of input matrices 102 and 104. Moreover, the column-dimension value (i.e., nblk) may be calculated as a function of the row-dimension value (i.e., mblk), allowing for more optimal register utilization.

According to some aspects, the valid configurations of the register tile may be determined based on a specific constraint. The constraint stipulates that the total number registers required for each load/store operation (i.e., the number of registers to store matrix elements in the tile and associated elements in the to-be-multiplied matrices) must be less than or equal to the total number of registers provided by the processor, i.e., f_{c}(h,i)+f_{A}(h)+f_{B}(i)≤N, where N is the total number of registers provided by the processor, f_{c}(h,i) is the number of registers used to store elements from product matrix C, f_{A}(h) is the number of registers used to store elements from multiplier matrix A, and f_{B}(i) is the number of registers used to store elements from multiplicand matrix B. This constraint ensures that the chosen tile configurations can be efficiently executed within the processor's available resources. It prevents the selection of tile sizes that would lead to register spilling, which occurs when there are not enough registers to hold all necessary data, resulting in costly memory operations.

The example pseudocode for determining all valid configurations of a register tile given a total number of registers in the processor is shown below:

```
for h = 1 : N − 1 {
  i = 0
  while f_{C} (h, i + 1) + f_{A} (h) + f_{B} (i + 1) ≤ N {
    if (i + 1) + h ≤ N {
      i = i + 1
    } else {
      break
    }
  }
  if i > 0 {
    print h × i
  } else {
    break
  }
}.
```

The above example code includes two nested loops designed to identify valid tile configurations. The outer loop iterates over a number of registers in the row dimension (i.e., h) from 1 to N-1, and the inner loop iterates over a number of registers in the column dimension (i.e., i). The goal is to identify all possible h-i pairs that satisfy the constraint (i.e., f_{c}(h,i)+f_{A}(h)+f_{B}(i)≤N). For the aforementioned matrix multiplication implementation using the out-of-place/copy algorithm with local buffering, the constraint becomes h*i+2*h+min(2,i) N. There can be many valid tile configurations. For example, given N=32 and h=1, the possible values of i may range from 1 to 28. Because smaller tile sizes may lead to a larger number of iterations, it is desirable to select a tile with maximum dimensions that still satisfy the constraint. For an implementation with m/n/k loop ordering, the register-blocking logic may first determine the tile size in the m dimension (i.e., the maximum h value for a given multiplier matrix) and then determine the tile size in the n dimension (i.e., the maximum i value corresponding to the determined h value).

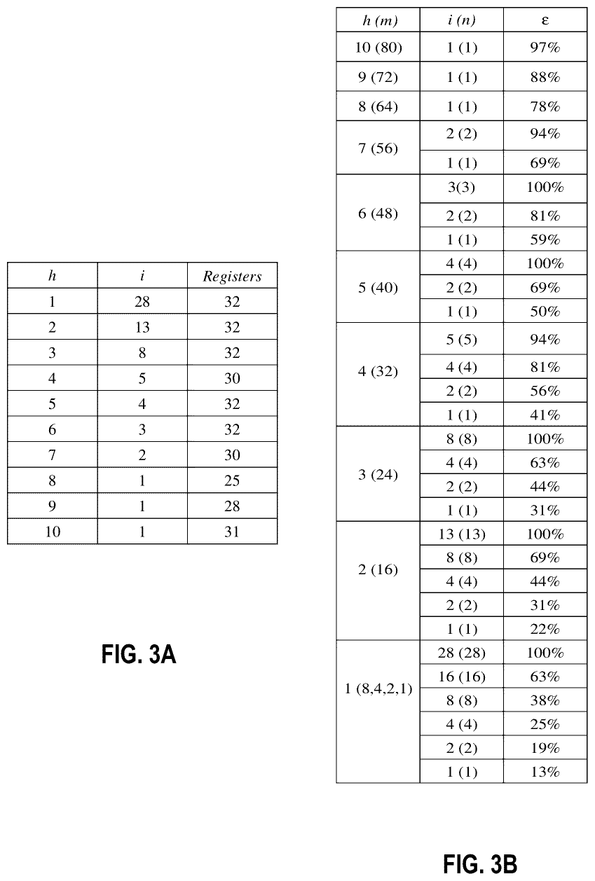

FIG. 3A illustrates a table presenting a list of valid tile configurations for a processor equipped with 32 registers for the out-of-place implementation, according to one aspect of the instant disclosure. The first column of the table lists all possible values of h, and the second column lists the maximum i values corresponding to the h values. For example, when h=1, iₘₐₓ=28; when h=2, iₘₐₓ=13, etc. The third column shows the number of registers used for each load/store operation for the given tile configuration. As can be seen from FIG. 3A, five tile configurations use all 32 registers. This is a significant improvement over the fixed-tile approach shown in FIG. 2, where only one configuration provides optimal utilization. Even in the worst-case scenarios under this adaptive approach, the register utilization is comparable to the cases shown in FIG. 2. This suggests that the variable tiling technique maintains or improves upon the efficiency of the fixed-tile method across all matrix sizes.

As discussed previously, the input multiplier and multiplicand matrices may not be divisible by the tile with maximum allowable dimensions, and the register blocking logic needs to handle loop remainders. According to some aspects, the column-dimension tile sizes for the loop remainders may be determined based on the current row-dimension tile size (i.e., the i values depend on the current h value). The dependency between row and column dimensions allows for more adaptive tiling. Within a given row-dimension loop (e.g., the m loop), the register blocking logic may first determine all possible i values corresponding to the current h value. Starting from the maximum i value, the logic may check whether each h-i combination may be used for a tile configuration. According to alternative aspects, for a given h value, the corresponding i values may include a maximum value and values that are powers of two and smaller than the maximum value. For example, when h=1, iₘₐₓ=28, and the rest of possible i values may include 2⁴=16, 2³=8, 2²=4, 2¹=2, and 2⁰=1. In other words, possible register tiles used to partition a product matrix C may have configurations of 1×28, 1×16, 1×8, 1×4, 1×2, and 1×1. Similarly, when h=2, iₘₐₓ=13, and the rest of i values may include 2³=8, 2²=4, 2¹=2, and 2⁰=1. This approach provides a balance between flexibility and simplicity in tile sizing.

FIG. 3B illustrates a table presenting a list of valid tile configurations and their corresponding register utilizations for the out-of-place implementation, according to one aspect of the instant disclosure. The table in FIG. 3B shows that, among the possible tile configurations, there are five h-i combinations (i.e., 6-3, 5-4, 3-8, 2-13, and 1-28) that can provide 100% register utilization. The average register utilization is 56%, which is much higher than the example shown in FIG. 2.

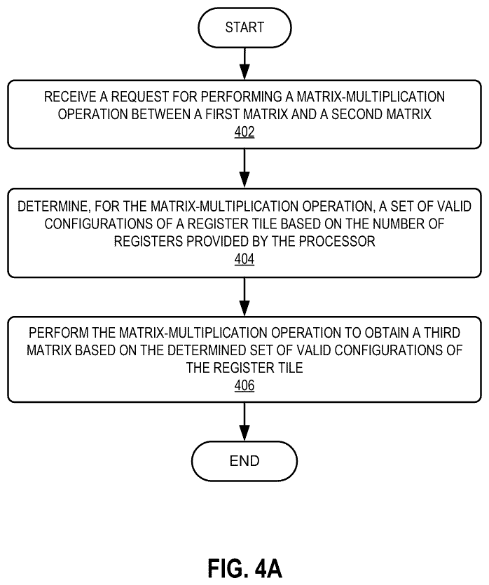

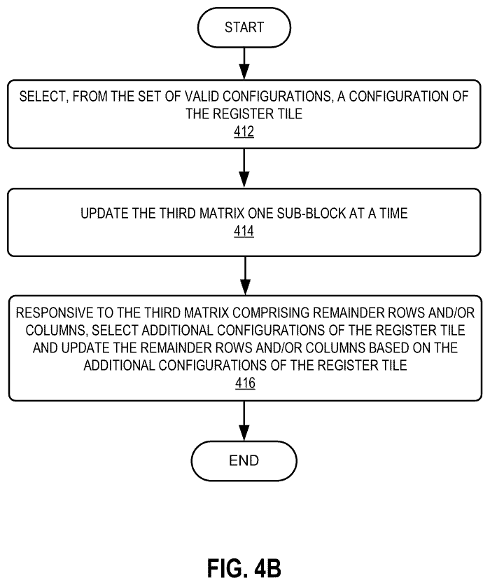

FIG. 4A presents a flowchart illustrating an example process for performing a matrix-multiplication operation, according to one aspect of the instant disclosure. All or any portion of the operations shown in FIG. 4A may be performed by a processor executing instructions. Although the example process in FIG. 4A shows a specific order for performing certain operations, the process is not limited to such an order. Operations shown in succession in the flowchart may be performed in a different order and may be executed concurrently or with partial concurrence or combinations thereof.

During operation, a processor may receive a request for performing a matrix-multiplication operation between a first matrix and a second matrix (operation 402). The two matrices may have arbitrary dimensions (e.g., rows and columns), given that the number of columns in the multiplier matrix (e.g., the first matrix) equals the number of rows in the multiplicand matrix (e.g., the second matrix). The processor may return an error message if such a condition is not met.

The processor may determine, for the matrix-multiplication operation, a set of valid configurations of a register tile based on the number of registers provided by the processor (operation 404). The register tile may be used in a register blocking scheme, which divides the product matrix into sub-blocks and calculates each sub-block independently to improve performance. A respective configuration of the register tile may include a row number defining the number of rows (denoted mblk) in the tile and a column number defining the number of columns (denoted nblk) in the tile. The column number is a function of the row number. According to some aspects, the valid configurations of the register tile may be determined by finding all h-i pairs satisfying the following constraint: f_{c}(h,i)+f_{A}(h)+f_{B}(i)≤N, where Nis the total number of registers provided by the processor, f_{c}(h,i) is the number of registers used to store elements from product matrix C, f_{A}(h) is the number of registers used to store elements from multiplier matrix A, and f_{B}(i) is the number of registers used to store elements from multiplicand matrix B. If the memory access for loading data of the input matrices is an out-of-place/copy algorithm with local buffering, the constraint becomes h*i+2*h+min(2,i)≤N. In one example, the processor may include 32 floating-point registers, and a set of valid configurations of the register tile may be similar to those shown in FIG. 3B.

Each register may have a predetermined vector length (denoted l) corresponding to the number of matrix elements held in the register. According to some aspects, the row number of the register tile equals the number of registers in a column times the vector length (i.e., mblk=h*l), and the column number of the register tile equals the number of registers in a row (i.e., nblk=i).

The processor may then perform the matrix-multiplication operation to obtain a third matrix based on the determined set of valid configurations of the register tile (operation 406). The third matrix is the product matrix of the first and second matrices. The number of rows in the third matrix equals the number of rows in the first matrix, and the number of columns in the third matrix equals the number of columns in the second matrix.

FIG. 4B presents a flowchart illustrating an example process for obtaining the product matrix, according to one aspect of the instant disclosure. All or any portion of the operations shown in FIG. 4B may be performed by a processor executing instructions. Although the example process in FIG. 4B shows a specific order for performing certain operations, the process is not limited to such an order. Operations shown in succession in the flowchart may be performed in a different order and may be executed concurrently or with partial concurrence or combinations thereof.

During operation, the processor may select, from the set of valid configurations, a configuration of the register tile (operation 412). Depending on the loop ordering, the processor may first select a maximum row number or maximum column number of the valid configurations. In one example, the m/n/k loop ordering is used (meaning that the outermost loop iterates over the row number), and the processor may first select a maximum row number satisfying the constraint f_{c}(h,i)+f_{A}(h)+f_{B}(i)≤N. The processor may further determine a set of column numbers corresponding to the maximum row number and select the maximum column number within the set. The number of rows in the register tile with the selected configuration equals the maximum row number, and the number of columns equals the maximum column number.

The processor may update the third matrix one sub-block at a time (operation 414). Each sub-block may include a subset of rows and columns of the third matrix corresponding to the selected configuration of the register tile, i.e., the numbers of rows and columns in the sub-block equal the numbers of rows and columns in the register tile, respectively. According to some aspects, to update a sub-block of the third matrix, the processor may allocate an appropriate number of registers in the processor to load matrix elements of the first and second matrices from memory, perform vectorized dot product on the matrix elements, and accumulate the result. The allocation of the registers may be determined based on the selected configuration of the register tile.

Responsive to the third matrix comprising remainder rows and/or columns, the processor may select additional configurations of the register tile and update the remainder rows and columns based on the additional configurations of the register tile (operation 416). According to some aspects, the professor may sort the row numbers of the valid configurations in descending order. Moreover, for each row number, the processor may sort the column numbers corresponding to the row number in descending order. The processor may then select each additional configuration of the register tile based on the sorted row and column numbers. In some examples, the processor may first update the third matrix one sub-block at a time along the column dimension. In response to detecting remainder columns, the processor may select the next largest column number corresponding to the current row number for form an additional smaller tile and update the remainder columns using the additional smaller tile. The processor may repeat the process until all remainder columns within the current rows have been updated. The processor may then update the third matrix along the row dimension. In response to detecting remainder rows, the processor may select the next largest row number and repeat the process until all remainder rows have been updated.

The example pseudocode for performing the matrix multiplication is shown below:

```
define mblkᵢ = [mblk₁ , mblk₂ ,..., mblkₓ ]
define nblkᵢⱼ = [[nblk₁ , nblk₂ ,..., nblk_{y} ]₁ ,...,[nblk₁ , nblk₂ ,..., nblk_{y} ]ₓ ]
m_loop:
do {
  reset n
  n_loop:
  do {
    reset k
  duplicate mblkᵢ code for i = 1...x
  if m < mblkᵢ{
    jump mblkᵢ₊₁
  } else {
    mblk* = mblkᵢ
    duplicate nblkᵢⱼ code for j = 1...y
    if n < nblkᵢⱼ {
      jump nblkᵢ₍ⱼ₊₁₎
    } else {
      while k > 0 {
        C = AB (local)
        k = k − Δk
      }
      update C (global)
      n = n − nblkᵢⱼ
      if j = 1 then jump n_loop
      }
    jump n_loop
    }
  } while n > 0
  m = m − mblk*
} while m > 0
```

The first two lines of the above pseudocode define the row numbers and corresponding column numbers of a set of valid register tile configurations. The row numbers have been sorted in descending order, and each row number corresponds to a set of column numbers, which are also sorted in descending order. The row-dimension loop or the m_loop is the outermost loop, and the k_loop is the innermost loop with a step size of Δk. The loops start with the maximum row number and a corresponding maximum column number in the sorted lists and step down to the next row/column numbers when remainder rows or columns are detected (e.g., m<mblkᵢ and/or n<nblkᵢⱼ). According to some aspects, the above pseudocode may be implemented as a compute kernel for matrix multiplication. Compared with conventional approaches using a fixed base tile and a set of additional tiles associated with the fixed tile, the proposed matrix-multiplication method can provide a higher register utilization over a wider range of input matrices.

In addition to the out-of-place/copy with local buffering scheme, the processor may also load data from memory using an in-place/no-copy scheme, which may be optimized for small input matrices. Although generally referred to as a no-copy process, local data buffering can be used to improve performance. The term no-copy means that the process does not make calls to external code to pack matrix data. Function calls incur additional overhead. The input matrices can be loaded on-demand (streamed) or packed into local buffers for contiguous memory access. The data-load method depends on the data layout of the input matrix (column-wise versus row-wise) and the order in which the process accesses the matrix elements. Data reuse is another important consideration. The two input matrices can be streamed or buffered, resulting in four possible combinations, but libraries often stream or buffer both matrices for simplicity. However, the data layout of the input matrices is not relevant because the register tile pertains to the blocking of the product matrix.

If the in-place/no-copy algorithm is used for loading data of the input matrices into processor registers, the constraint for the register tile configuration may be expressed as h*i+h+min(2,i)≤N, where N is the total number of registers provided by the processor, h*i is the number of registers used to store elements from the product matrix, and the extra term 2*h+min(2,i) is the number of registers necessary for loading data from the input matrices without loop unrolling. This extra term is implementation-specific and may be defined differently.

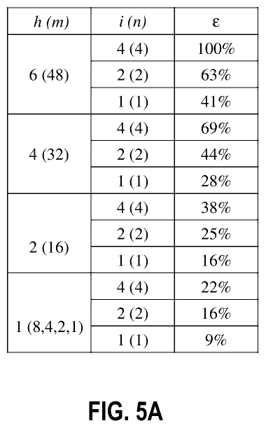

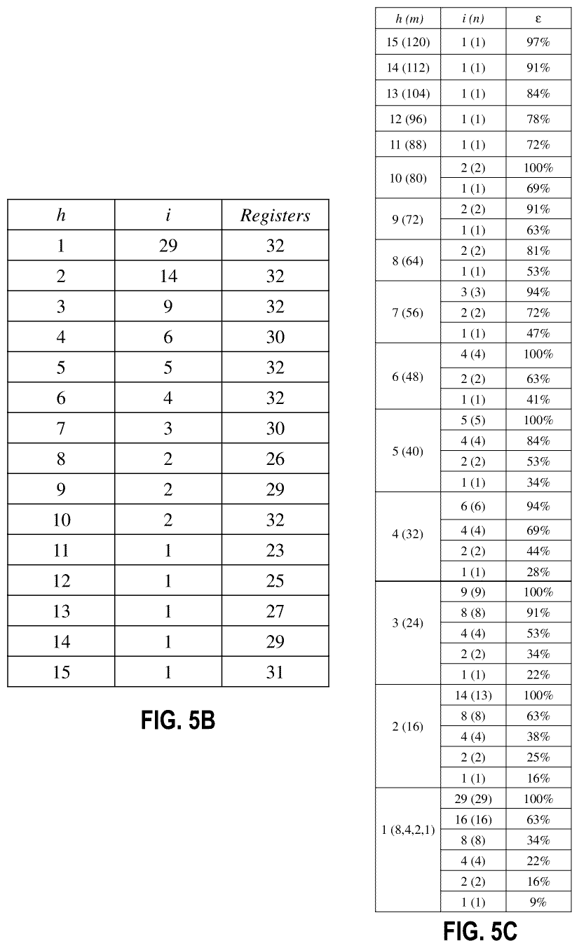

In some examples, the total number of registers in a processor is 32, and the constraint for the valid tile configuration becomes h*i+h+min(2,i)≤32. FIG. 5A illustrates a table indicating the register utilization for a set of fixed tile configurations for an in-place implementation. In this example, the base tile has a size of 6×4, and the average register utilization is only 29%. FIG. 5B illustrates a table presenting a list of valid tile configurations for the in-place implementation for a processor equipped with 32 registers, according to one aspect of the instant disclosure. FIG. 5C illustrates a table including a list of valid tile configurations and their corresponding register utilizations for the in-place implementation, according to one aspect of the instant disclosure. As shown in FIG. 5C, there are six tile configurations that can provide 100% register utilization. The average tile utilization is 56%, which is almost twice as efficient as the conventional implementation using a fixed base tile.

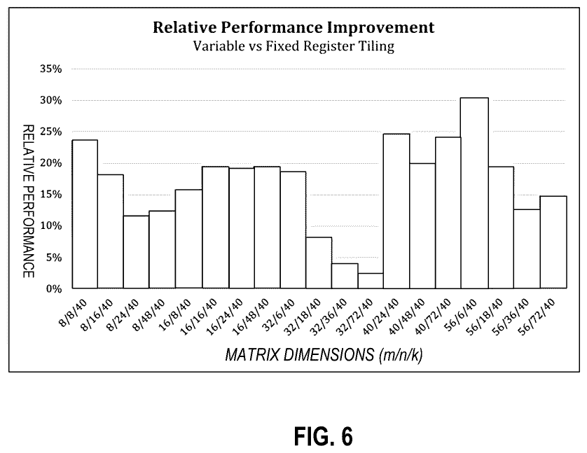

In addition to improving register utilization, the variable register tile scheme also improves the performance (in terms of speed) of matrix multiplication due to the reduced number of iterations. FIG. 6 illustrates the relative performance improvement of the variable register tiling technique over the conventional fixed register tiling technique for the in-place implementation, according to one aspect of the instant disclosure. In this example, the input matrices have a wide range (e.g., m ranges from 8 to 56), and the fixed register tiling scheme uses a base tile of size 6×4. The performance of the matrix-multiplication operation using the two tiling schemes is measured on an Intel Gold 6330 CPU. As can be seen from FIG. 6, the variable register tiling technique may boost the performance of the matrix-multiplication operation over different dimensions of the input matrices. There is a variation in the performance gain due to memory alignment, and the average [performance boost across all matrix dimensions is 16.81%.

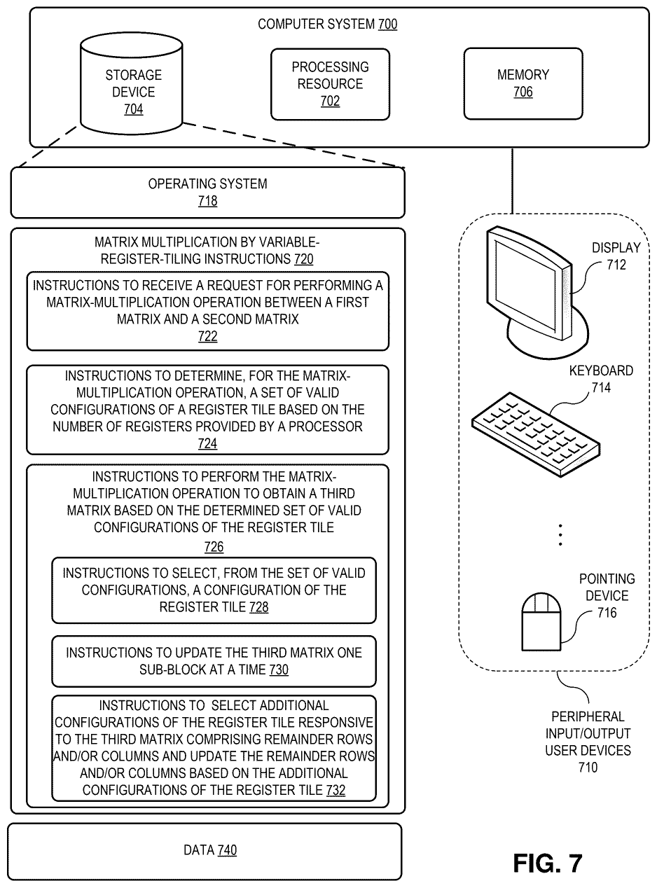

FIG. 7 illustrates an example computer system facilitating variable register tiling for matrix multiplication, according to one aspect of the instant disclosure.

Computer system 700 may include one or more processing resources (e.g., a processing resource 702), one or more storage devices (e.g., a storage device 704), and a memory 706. According to some aspects, processing resource 702 may include a number of registers (not shown in FIG. 7), such as floating-point registers, which may temporarily store data loaded from memory 706.

A processing resource may include, for example, one processor or multiple processors included in a single computing device or distributed across multiple computing devices. In some examples, the concurrent processes may be executed on a single computing device or multiple computing devices. As used herein, a “processor” may be at least one of a central processing unit (CPU), a semiconductor-based microprocessor, a graphics processing unit (GPU), a field-programmable gate array (FPGA) configured to retrieve and execute instructions, other electronic circuitry suitable for the retrieval and execution of instructions stored on a computer-readable storage medium, or a combination thereof. In the examples described herein, the processing resource may fetch, decode, and execute instructions stored on a storage medium to perform the functionalities described in relation to the instructions stored on the computer-readable medium. In other examples, the functionalities described in relation to any instructions described herein may be implemented in the form of electronic circuitry, in the form of executable instructions encoded on a computer-readable medium, or a combination thereof. The computer-readable storage medium may be located either in the computing device executing the instructions, or remote from but accessible to the computing device (e.g., via a computer network) for execution. In the examples illustrated herein, the node may be implemented by one computer-readable storage medium or multiple computer-readable storage media.

Computer system 700 can be coupled to peripheral 1/O user devices 710 (e.g., a display device 712, a keyboard 714, and a pointing device 716). Storage device 704 includes a non-transitory computer-readable storage medium and stores an operating system 718, matrix-multiplication by variable-register-tiling instructions 720, and data 740. Computer system 700 may include fewer or more entities than those shown in FIG. 7. According to some aspects, computer system 700 may be implemented by a standalone device or a compute node within a data center.

Matrix multiplication by variable-register-tiling instructions 720 may include instructions, which when executed by computer system 700, can cause computer system 700 to perform methods and/or processes described in this disclosure. Matrix-multiplication by variable-register-tiling instructions 720 can be executed at least on processing resource 702.

Matrix multiplication by variable-register-tiling instructions 720 may include instructions 722 to receive a request for performing a matrix-multiplication operation between a first matrix and a second matrix, as described above in relation to operation 402 shown in FIG. 4A. The first matrix is often referred to as matrix A, and the second matrix is often referred to as matrix B. The matrix-multiplication operation may be part of a machine learning workflow. For example, in machine learning, features are often represented as matrices, which may be multiplied with weight matrices to transform a dataset into new representations.

Matrix multiplication by variable-register-tiling instructions 720 may include instructions 724 to determine, for the matrix-multiplication operation, a set of valid configurations of a register tile based on the number of registers provided by a processor, as described above in relation to operation 404 shown in FIG. 4A. The processor may be part of processing resource 702. A respective configuration of the register tile may include a row number defining the number of rows (in terms of rows in the product matrix C) in the tile and a column number defining the number of columns (in terms of columns in the product matrix C) in the tile. The column number may be a function of the row number. According to some aspects, the valid configurations of the register tile may be determined by finding all h-i pairs satisfying the following constraint: f_{c}(h,i)+f_{A}(h)+f_{B}(i)≤N, where Nis the total number of registers provided by the processor, f_{c}(h,i) is the number of registers used to store elements from product matrix C, f_{A}(h) is the number of registers used to store elements from multiplier matrix A, and f_{B}(i) is the number of registers used to store elements from multiplicand matrix B.

Matrix multiplication by variable-register-tiling instructions 720 may include instructions 726 to perform the matrix-multiplication operation to obtain a third matrix based on the determined set of valid configurations of the register tile, as described above in relation to operation 406 shown in FIG. 4A. Instructions 726 may further include instructions 728 to select, from the set of valid configurations, a configuration of the register tile, as described above in relation to operation 412 shown in FIG. 4B. The selected configuration may have the largest row number or column number, depending on whether the register tile steps through the product matrix in the row dimension or the column dimension. If the row number is selected, a set of column numbers corresponding to the row number may be determined, and the largest column number within the set may be selected.

Instructions 726 may include instructions 730 to update the third matrix one sub-block at a time, as described above in relation to operation 414 shown in FIG. 4B. Each sub-block in the third matrix (i.e., the product matrix) has the same size and dimensions as the register tiles. Instructions 730 may include instructions to allocate registers to load matrix elements of the first and second matrices from memory (e.g., memory 706), instructions to perform vectorized dot product on the matrix elements, and instructions to accumulate the result to update the sub-block.

Instructions 726 may include instructions 732 to select additional configurations of the register tile responsive to the third matrix comprising remainder rows and/or columns and to update the remainder rows and columns based on the additional configurations of the register tile, as described above in relation to operation 416 shown in FIG. 4B. Because the product matrix may not be divisible by the previously selected register tile configuration, there may be remainder columns or rows after the register tile steps through the column or row dimension, respectively. To update the remainder rows and/or columns, additional smaller register tiles may be used. In some examples, the row or column number of the smaller tiles may be powers of two.

Matrix multiplication by variable-register-tiling instructions 720 may include more instructions than those shown in FIG. 7. For example, matrix multiplication by variable-register-tiling instructions 720 may include instructions to sort the row numbers of the valid tile configurations in descending order and instructions to sort, for each row number, a set of corresponding column numbers in descending order.

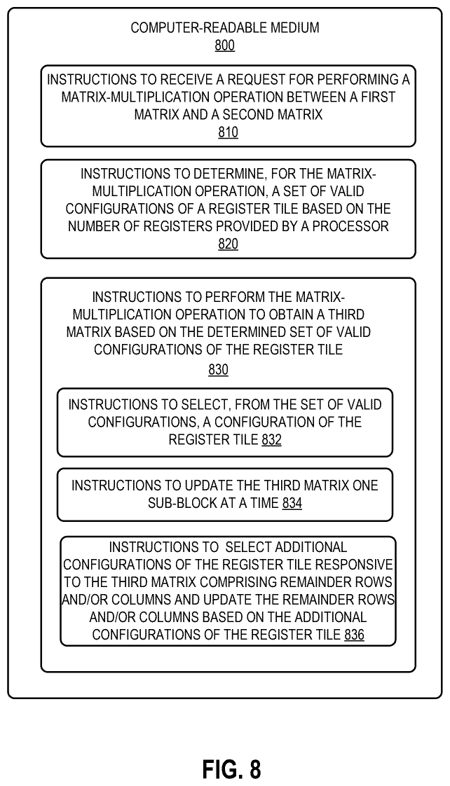

FIG. 8 illustrates a computer-readable medium (CRM) that facilitates matrix multiplication by variable-register-tiling, according to one aspect of the instant disclosure. CRM 800 may be a non-transitory computer-readable medium or device storing instructions that when executed by a computer or processing resource cause the computer or processing resource to perform a method. As used herein, a “computer-readable storage medium” may be any electronic, magnetic, optical, or other physical storage apparatus to contain or store information such as executable instructions, data, and the like. For example, any computer-readable storage medium described herein may be any of RAM, EEPROM, volatile memory, non-volatile memory, flash memory, a storage drive (e.g., an HDD, an SSD), any type of storage disc (e.g., a compact disc, a DVD, etc.), or the like, or a combination thereof. Further, any computer-readable storage medium described herein may be non-transitory.

CRM 800 may store instructions 810 to receive a request for performing a matrix-multiplication operation between a first matrix and a second matrix, as described above in relation to operation 402 shown in FIG. 4A; instructions 820 to determine, for the matrix-multiplication operation, a set of valid configurations of a register tile based on the number of registers provided by a processor, as described above in relation to operation 404 shown in FIG. 4A; and instructions 830 to perform the matrix-multiplication operation to obtain a third matrix based on the determined set of valid configurations of the register tile, as described above in relation to operation 406 shown in FIG. 4A. Instructions 830 may further include instructions 832 to select, from the set of valid configurations, a configuration of the register tile, as described above in relation to operation 412 shown in FIG. 4B; instructions 834 to update the third matrix one sub-block at a time, as described above in relation to operation 414 shown in FIG. 4B; and instructions 836 to select additional configurations of the register tile responsive to the third matrix comprising remainder rows and/or columns and to update the remainder rows and columns based on the additional configurations of the register tile, as described above in relation to operation 416 shown in FIG. 4B.

CRM 800 may include more instructions than those shown in FIG. 8. For example, CRM 800 may include instructions to sort the row numbers of the valid tile configurations in descending order and instructions to sort, for each row number, a set of corresponding column numbers in descending order.

In general, aspects of the disclosure provide a solution to improve the performance of matrix multiplication, especially for small matrices that are widely used in machine learning applications. More specifically, the disclosed system may use a variable register tiling technique that considers all valid tile configurations when dividing the product matrix into sub-blocks. In one example, the valid tile configurations may be determined based on a constraint, which states that the number of registers necessary to store a tile of the product matrix and associated elements in the input matrices is less than the total number of registers provided by the processor. For a tile configuration with a given number of rows, the maximum number of columns may be determined based on an implementation-specific (e.g., out-of-place/copy or in-place/no-copy) register allocation formula. When performing the matrix-multiplication operation, the system may update the product matrix one tile at a time. In response to detecting remainder rows and/or columns, the disclosed system may select additional configurations of the register tile and update the remainder rows and columns based on the additional configurations of the register tile. This approach can improve register utilization, which is a dominant factor affecting the performance of multiplications of small matrices. In some examples, the solution may be implemented as a compute kernel for matrix multiplication. The compute kernel may include assembly language statements for allocation registers in the processor.

One aspect of the instant disclosure provides a system and method for improving register utilization in a processor. During operation, the processor may receive a request for performing a matrix-multiplication operation between a first matrix and a second matrix; and determine, for the matrix-multiplication operation, a set of valid configurations of a register tile based on a number of registers provided by the processor, a respective configuration comprising a row number and a column number. The column number is a function of the row number. The processor may then perform the matrix-multiplication operation to obtain a third matrix based on the determined set of valid configurations of the register tile. The matrix-multiplication operation may include selecting, from the set of valid configurations, a configuration of the register tile; updating the third matrix one sub-block at a time, the sub-block comprising a subset of rows and columns of the third matrix corresponding to the selected configuration of the register tile; and responsive to the third matrix comprising remainder rows and columns, selecting additional configurations of the register tile and updating the remainder rows and columns based on the additional configurations of the register tile.

In a variation on this aspect, selecting the configuration of the register tile may include selecting a maximum row number, determining a set of column numbers corresponding to the maximum row number, and selecting a maximum column number based on the set of column numbers.

In a variation on this aspect, selecting the additional configurations of the register file may include sorting row numbers of the valid configurations in descending order; for each row number, sorting column numbers corresponding to the row number in descending order; and selecting each additional configuration of the register tile based on the sorted row and column numbers.

In a variation on this aspect, determining the set of valid configurations of the register tile may include determining a number of registers needed to store elements in the sub-block and determining a number of registers needed to load elements of the first and second matrices.

In a further variation, determining the set of valid configurations of the register tile may further include identifying row numbers and column numbers that result in a sum of the number of registers needed to store the elements in the sub-block and the number of registers needed to load the elements of first and second matrices being no greater than the number of registers provided by the processor.

In a further variation, performing the matrix-multiplication operation may include applying an in-place algorithm; and, for each valid configuration with identified row and column numbers, the number of registers allocated to load the elements of the first matrix equals the row number and the number of registers allocated to load the elements of the second matrix equals the lesser of two and the column number.

In a further variation, performing the matrix-multiplication operation may include applying an out-of-place algorithm; and, for each valid configuration with identified row and column numbers, the number of registers needed to load the elements of the first matrix equals twice the row number and the number of registers needed to load the elements of the second matrix equals the lesser one of two and the column number.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

The methods and processes described above can be included in hardware modules or apparatuses. The hardware modules or apparatus can include, but are not limited to, application-specific integrated circuit (ASIC) chips, field-programmable gate arrays (FPGAs), dedicated or shared processors that execute a particular software module or a piece of code at a particular time, and other programmable-logic devices now known or later developed. When the hardware modules or apparatus are activated, they perform the methods and processes included within them.

The foregoing description is presented to enable any person skilled in the art to make and use the aspects and examples and is provided in the context of a particular application and its requirements. Various modifications to the disclosed aspects will be readily apparent to those skilled in the art, and the general principles defined herein may be applied to other aspects and applications without departing from the spirit and scope of the present disclosure. Thus, the aspects described herein are not limited to the aspects shown but are to be accorded the widest scope consistent with the principles and features disclosed herein.

Furthermore, the foregoing descriptions of aspects have been presented for purposes of illustration and description only. They are not intended to be exhaustive or to limit the aspects described herein to the forms disclosed. Accordingly, many modifications and variations will be apparent to practitioners skilled in the art. Additionally, the above disclosure is not intended to limit the aspects described herein. The scope of the aspects described herein is defined by the appended claims.

What is claimed is:

1. A computer-implemented method for improving register utilization in a processor, the method comprising:
receiving, at the processor, a request for performing a matrix-multiplication operation between a first matrix and a second matrix;
determining, for the matrix-multiplication operation, a set of valid configurations of a register tile based on a number of registers provided by the processor, a respective configuration comprising a row number and a column number, the column number being a function of the row number; and
performing the matrix-multiplication operation to obtain a third matrix based on the determined set of valid configurations of the register tile, the matrix-multiplication operation comprising:
selecting, from the set of valid configurations, a configuration of the register tile;
updating the third matrix one sub-block at a time, the sub-block comprising a subset of rows and columns of the third matrix corresponding to the selected configuration of the register tile; and
responsive to the third matrix comprising remainder rows and columns, selecting additional configurations of the register tile and updating the remainder rows and columns based on the additional configurations of the register tile.

2. The computer-implemented method of claim 1, wherein selecting the configuration of the register tile comprises:
selecting a maximum row number;
determining a set of column numbers corresponding to the maximum row number; and
selecting a maximum column number based on the set of column numbers.

3. The computer-implemented method of claim 1, wherein selecting the additional configurations of the register file comprises:
sorting row numbers of the valid configurations in descending order;
for each row number, sorting column numbers corresponding to the row number in descending order; and
selecting each additional configuration of the register tile based on the sorted row and column numbers.

4. The computer-implemented method of claim 1, wherein determining the set of valid configurations of the register tile comprises determining a number of registers needed to store elements in the sub-block and determining a number of registers needed to load elements of the first and second matrices.

5. The computer-implemented method of claim 4, wherein determining the set of valid configurations of the register tile further comprises:
identifying row numbers and column numbers that result in a sum of the number of registers needed to store the elements in the sub-block and the number of registers needed to load the elements of first and second matrices being no greater than the number of registers provided by the processor.

6. The computer-implemented method of claim 4,
wherein performing the matrix-multiplication operation comprises applying an in-place algorithm; and
wherein, for each valid configuration with identified row and column numbers, the number of registers allocated to load the elements of the first matrix equals the row number and the number of registers allocated to load the elements of the second matrix equals the lesser of two and the column number.

7. The computer-implemented method of claim 4,
wherein performing the matrix-multiplication operation comprises applying an out-of-place algorithm; and
wherein, for each valid configuration with identified row and column numbers, the number of registers needed to load the elements of the first matrix equals twice the row number and the number of registers needed to load the elements of the second matrix equals the lesser one of two and the column number.

8. A computer system, comprising:
at least one processing resource; and
a non-transitory computer-readable storage medium storing instructions that when executed by the processing resource cause the computer system to:
receive a request for performing a matrix-multiplication operation between a first matrix and a second matrix;
determine, for the matrix-multiplication operation, a set of valid configurations of a register tile based on a number of registers provided by the at least one processing resource, a respective configuration comprising a row number and a column number, the column number being a function of the row number; and
perform the matrix-multiplication operation to obtain a third matrix based on the determined set of valid configurations of the register tile, the matrix-multiplication operation comprising:
selecting, from the set of valid configurations, a configuration of the register tile;
updating the third matrix one sub-block at a time, the sub-block comprising a subset of rows and columns of the third matrix corresponding to the selected configuration of the register tile; and
responsive the third matrix comprising remainder rows and columns, selecting additional configurations of the register tile and updating the remainder rows and columns based on the additional configurations of the register tile.

9. The computer system of claim 8, wherein selecting the configuration of the register tile comprises:
selecting a maximum row number;
determining a set of column numbers corresponding to the maximum row number; and
selecting a maximum column number based on the set of column numbers.

10. The computer system of claim 8, wherein selecting the additional configurations of the register file comprises:
sorting row numbers of the valid configurations in descending order;
for each row number, sorting column numbers corresponding to the row number in descending order; and
selecting each additional configuration of the register tile based on the sorted row and column numbers.

11. The computer system of claim 8, wherein determining the set of valid configurations of the register tile comprises determining a number of registers needed to store elements in the sub-block and determining a number of registers needed to load elements of the first and second matrices.

12. The computer system of claim 11, wherein determining the set of valid configurations of the register tile further comprises:
identifying row numbers and column numbers that result in a sum of the number of registers needed to store the elements in the sub-block and the number of registers needed to load the elements of first and second matrices being no greater than the number of registers provided by the processor.

13. The computer system of claim 11,
wherein performing the matrix-multiplication operation comprises applying an in-place algorithm; and
wherein, for each valid configuration with identified row and column numbers, the number of registers allocated to load the elements of the first matrix equals the row number and the number of registers allocated to load the elements of the second matrix equals the lesser of two and the column number.

14. The computer system of claim 11,
wherein performing the matrix-multiplication operation comprises applying an out-of-place algorithm; and
wherein, for each valid configuration with identified row and column numbers, the number of registers needed to load the elements of the first matrix equals twice the row number and the number of registers needed to load the elements of the second matrix equals the lesser one of two and the column number.

15. A non-transitory computer-readable storage medium storing instructions which when executed by a processor cause the processor to perform a method, the method comprising:
receiving, at the processor, a request for performing a matrix-multiplication operation between a first matrix and a second matrix;
determining, for the matrix-multiplication operation, a set of valid configurations of a register tile based on a number of registers provided by the processor, a respective configuration comprising a row number and a column number, the column number being a function of the row number; and
performing the matrix-multiplication operation to obtain a third matrix based on the determined set of valid configurations of the register tile, the matrix-multiplication operation comprising:
selecting, from the set of valid configurations, a configuration of the register tile;
updating the third matrix one sub-block at a time, the sub-block comprising a subset of rows and columns of the third matrix corresponding to the selected configuration of the register tile; and
responsive the third matrix comprising remainder rows and columns, selecting additional configurations of the register tile and updating the remainder rows and columns based on the additional configurations of the register tile.

16. The non-transitory computer-readable storage medium of claim 15,
wherein selecting the configuration of the register tile comprises:
selecting a maximum row number;
determining a set of column numbers corresponding to the maximum row number; and
selecting a maximum column number based on the set of column numbers; and
wherein selecting the additional configurations of the register file comprises:
sorting row numbers of the valid configurations in descending order;
for each row number, sorting column numbers corresponding to the row number in descending order; and
selecting each additional configuration of the register file one by one according to the sorted row and column numbers.

17. The non-transitory computer-readable storage medium of claim 15, wherein determining the set of valid configurations of the register tile comprises determining a number of registers needed to store elements in the sub-block and determining a number of registers needed to load elements of the first and second matrices.

18. The non-transitory computer-readable storage medium of claim 17, wherein determining the set of valid configurations of the register tile further comprises:
identifying row numbers and column numbers that result in a sum of the number of registers needed to store the elements in the sub-block and the number of registers needed to load the elements of first and second matrices being no greater than the number of registers provided by the processor.

19. The non-transitory computer-readable storage medium of claim 17,
wherein performing the matrix-multiplication operation comprises applying an in-place algorithm; and
wherein, for each valid configuration with identified row and column numbers, the number of registers allocated to load the elements of the first matrix equals the row number and the number of registers allocated to load the elements of the second matrix equals the lesser of two and the column number.

20. The non-transitory computer-readable storage medium of claim 17,
wherein performing the matrix-multiplication operation comprises applying an out-of-place algorithm; and
wherein, for each valid configuration with identified row and column numbers, the number of registers needed to load the elements of the first matrix equals twice the row number and the number of registers needed to load the elements of the second matrix equals the lesser one of two and the column number.
